(19) United States
(12) Patent Application Publication
(10) Pub. No.: US 2020/0054060 A1
(43) Pub. Date: Feb. 20, 2020

(54) NATURAL PRODUCT ENZYME USING LACTIC ACID BACTERIA, AND PREPARATION METHOD THEREOF

(71) Applicant: Seungchan KANG, Jeju-do (KR)

(72) Inventor: Seungchan KANG, Jeju-do (KR)

(21) Appl. No.: 16/609,313

(22) PCT Filed: May 19, 2017
(86) PCT No.: PCT/KR2017/005218

§ 371 Date: Oct. 29, 2019

(30) Foreign Application Priority Data
May 15, 2017 (KR) 10-2017-0060207

(51) Int. Cl. A23L 33/135; A23L 29/00

(52) U.S. Cl. CPC A23L 33/135; A23L 29/00

(57) ABSTRACT

Provided is a natural product enzyme containing lactic acid bacteria and a method for producing the same, and more particularly a natural product-derived fermented enzyme obtained by inoculating lactic acid bacteria into natural products, including ginseng, Korean dendropanax, perilla, onion and seaweed, followed by fermentation, and a method for producing the same. The natural product enzyme produced by the method of producing the natural product enzyme using lactic acid bacterial according to the present invention makes it possible to effectively use the natural physiologically active components contained in the natural products and the active components which are additionally produced by lactic acid bacteria fermentation.

### BACKGROUND

The present invention relates to a natural product enzyme containing lactic acid bacteria and a method for producing the same, and more particularly to a natural product-derived fermented enzyme obtained by inoculating lactic acid bacteria into natural products, including ginseng, Korean dendropanax, perilla, onion and seaweed, followed by fermentation, and a method for producing the same.

Lactic acid bacteria are anaerobic bacteria that live in the gut of humans and mammals and are important microorganisms that prevent abnormal fermentation caused by intestinal spoilage bacteria. The major bacteria belonging to lactic acid bacteria include lactic acid bacilli, lactic acid cocci, bifidus bacteria and the like, and are widely used in foods, such as fermented milk, lactic acid bacteria drinks, cheese, Doenjang (soybean paste) and kimchi, as well as pharmaceutical products. Lactic acid bacteria settle in the intestine and exhibit various physiological activities, including intestinal regulation, inhibition of harmful bacteria, production of vitamins and immune-enhancing substances, anticancer effects, and lowering of blood cholesterol levels.

Meanwhile, ginseng is named after the root shaped like the human body, and is also called demon plant because of having demon-like effects. In addition, it is also called “Inham” in Korean in the sense that it belongs to a high rank and is respected by humans. Furthermore, it is also called “Guigae” in Korean because it faces shade against the sun. In addition, it got the name “Tojeong” in Korean because someone heard human calling every night from behind the house and when he dug the ground of the place, there was a human-shaped herb, and after he pulled the herb out of the ground, he no longer heard the calling. Ginseng has a peculiar smell, tastes sweet and slightly bitter, and is slightly warm in nature. In addition, ginseng is rejuvenated, physical weakness, boredom, fatigue, anorexia, vomiting, diarrhea is used to help pulmonary function, produce essence and increase the function and renal function. In addition, ginseng boosts energy, is used for physical weakness, boredom, fatigue, anorexia, vomiting, and diarrhea, helps pulmonary function, produces essence, and enhances ophthalmic nerve function and renal function. Ginseng has been reported to have pharmacological actions including cerebral cortex excitement and inhibition balance, anti-fatigue, anti-aging, immune enhancement, heart contraction, gonadotropic activity, hyperglycemia suppression, protein synthesis promotion, maintenance of homeostasis, anticancer, detoxification activities, etc. The appearance of ginseng is thin and long columnar or fusiform with 2 to 5 side roots, and the outer side is light yellowish brown with vertical wrinkles and thin root marks. The root head has an outcrop with stem twigs attached. The leave, outcrop and seed of ginseng are used as medicines.

Korean dendropanax (“Hwangchil” (in Korean) tree) has been used to color or process the surface of woodwork products. It grows to a height of 15 m, and its young branches are green and have no hairs. The leaves are alternate and oval in shape. In addition, the leaf edge is flat, but in young trees, it is split into 3 to 5 pieces and jagged. The flower is light yellow-green in June to the middle of August, and it is hermaphrodite and hangs on the umber. The flower stalk is 3-5 cm long and a small flower stalk is 5-10 mm long. The calyx is split into 5 pieces, the flower has five petals and five stamens, and there is a nectary on the flower disk. The pistil head is split into 5 pieces, the fruit is elliptical, and the tree bears a black fruit at the end of September through November. The wood sap used for ‘Hwangchil’ (yellow lacquer) is collected in August through September. ‘Hwangchil’ is a traditional craft technique similar to Korean lacquer that applies a collected lacquer tree sap. When the Korean dendropanax epidermis is cut, a yellow liquid (sap) comes out, and “Hwangchil” means applying the collected yellow liquid. Traditionally, the yellow liquid has been used as a paint for furniture or a paint for metals and leather. Historically, the yellow liquid was classified as a tribute to China, and the suffering of people in the areas where Korean dendropanax grew was also severe. In the Joseon Dynasty, there was also a record that Korean dendropanax was cut down when grew. Korean dendropanax is native to Korea and is distributed in Jeollanam-do, Gyeongsangnam-do, and Jeju-do, Korea. In Japan, it is also distributed in southern Honshu and Okinawa. Korean dendropanax was considered an independent species in the past, but it is difficult to identify the morphological differences from the Japanese species Dendropanax morbiferus H. Lev., except for the color of the sap.

Perilla is also called Japanese perilla. Perilla is native to the highlands of India, South Central China, etc. In Korea, there is a record that perilla together with sesame was cultivated in the Unified Silla Era. Thus, it seems that perilla has been cultivated nationwide since ancient times. Perilla grows wild near houses in lowlands. The height is 60 to 90 cm. The stems are square, stand upright, and have long hairs. The leaves are opposite each other and have a pointed oval round shape, and the bottom is round. The leaves are 7-12 cm long, 5-8 cm wide, serrated, green on the front, but purple on the back. The flowers form a raceme in August to September, are white, and are mostly small lip-shaped flowers. The calyx is 3-4 mm long, and split into 3 pieces on the top and 2 pieces on the bottom. The corolla is 4 to 5 mm long, the lower lip petal is slightly longer, and 2 of 4 stamens is long. The fruits are mericarps inside the calyx, are round and about 2 mm in diameter, and have a net pattern on the outside. Although there are no established varieties, perilla is divided into several species depending on the morphological characteristics of the fruit, and in Korea, brown species are generally cultivated. Perilla is cultivated as an oil crop, and has an unusual smell on the leaves, and is edible. Oil squeezed from the seeds has many uses. In addition, it is used together with paints, varnishes, linoleum, printing inks or waterproofing lacquers, and is used as a raw material for pomades, soaps, etc. Furthermore, it is used for paper lacquered with oil. The oil cakes are used as feeds and fertilizers. Perilla contain about 40% dry oil. The leaves has about 0.4% volatile oil whose main component is perilla ketone having an unusual odor. Perilla is cultivated in Korea, China, India, Japan, etc.

It is presumed that onion is native to West Asia or the Mediterranean, but this presumption is not certain because but no wild species have yet been found. The history of onion cultivation is so old that murals of ancient Egyptian tombs around 3000 B.C. have records that garlic and onions were fed to the workers who built the pyramids, and it is known that onions have been cultivated in Greece since the 7^{th} to 8^{th} centuries BC. Onion bulbs vary slightly depending on the variety, but have a flat, round or round shape, include a thin filmy (translucent like a thin paper) purplish brown coat on the outside, and the inner scales are thick, lavered and taste spicy. The leaves are hollow cylinders, dark green, dry in bloom, and the lower portion thereof has thick, scaly patches. The flowers bloom white in September, form an umbel at the end of stalks between the leaves, and a large number of the flowers hang and are round like a ball. The stalk is columnar, 50 to 100 cm high, the lower part is swollen, and 2 to 3 leaves hang under it. The perianth is split into 6 pieces, and the split pieces are lanceolate in shape and spread horizontally. There are 6 stamens, 3 of which have fine protrusions on both sides under the stamen stalks, and there is one pistil. The varieties are divided into: those in which the bulbs have a round shape and a flat round shape; and those in which the coats of the bulbs are red, yellow and white. In addition, onions are divided into sweet onions and spicy onions according to taste. Commonly edible onion varieties are mainly composed of four types: yellow onions, red onions, white onions, and small onions. Onions are harvested mainly in June to July when the leaves fall and have a little green color, and the leaves are also used for edible purposes before the bulbs grow. Onion bulbs are mainly used for edible purposes, and the peculiar odor of the bulbs is due to compounds such as propyl disulfide and allyl sulfide. The onion bulb physiologically promotes the secretion of digestive juices and has excitement, sweating and diuretic effects, etc. In addition, the bulb contains minerals such as calcium and phosphoric acid along with various vitamins, and thus has the effect of removing harmful substances from the blood. The bulbs are often used in salads, soups, and meat dishes, and are also used as spices in various dishes. The leaves contain per 100 g, 5,000 IU vitamin A, 45 mg vitamin C, 80 mg calcium, 24 mg magnesium, and 220 mg potassium.

Seaweed is a food that can be eaten abundantly in quantity, and it is a food that has a fresh sea taste. Generally, seaweed contains about 10% protein and about 30-40% carbohydrates, but does not express calories because it is vegetable fiber. Seaweed is rich in various inorganic salts essential for good health, and also contains body composition nutrients such as proteins. Seaweeds such as laver, seaweed, and kelp are rich in potassium ions and are chemically very good alkaline health foods. Among them, laver is a health food with very good nutrients, and contains significantly large amounts of proteins and carbohydrates compared to other foods. In addition, seaweed has an effect as a health food for preventing adult diseases in that it is vegetable fiber. Ions generated from seaweed are absolutely necessary for metabolism because they are excreted in combination with acidic waste products in the body. Thus, the nature of seaweed contributes greatly to the direct excretion of wastes as well as to the elimination of secondary toxicity. Seaweed has an excellent function as a health food because it contains a large amount of alginic acid, a good-quality vegetable fiber. In particular, it helps the peristalsis of the large intestine, and thus is effective in relieving constipation. Seaweed contains a large amount of calcium ions (Ca++), and thus is effective in preventing osteoporosis or osteomalacia and preventing aging. In addition, iodine, which is abundant in seaweed, stimulates appetite, prevents thyroid edema, and softens hair. Raw laver has a fragrant sea odor, and contains a large amount of dietary fiber, similar to sea mustard, kelp or other seaweeds, and thus promotes the peristalsis of the large intestine to induce smooth waste excretion. That is, since seaweed contains a large amount of amino acids and is rich in in seaweed oligosaccharides which are receiving attention as highly functional natural materials, it is recognized as an ideal natural food. In addition, seaweed is rich in various minerals and vitamins. Recently, studies on the physiological efficacy of seaweeds have been actively conducted by domestic and foreign experts, and as a result, it has been revealed that seaweeds are deeply involved in weight loss, treatment of constipation by intestinal regulation, and discharge of heavy metals and radioactive substances from the body. In addition, it has been reported that sulfur-containing polysaccharides, which are commonly referred to as fucoidan, have antibacterial, antioxidant, antiviral and anticancer activities and are effective in preventing adult diseases such as atherosclerosis, myocardial infarction, hypertension, angina pectoris, stroke, etc.

### SUMMARY OF THE INVENTION

A problem to be solved by the present invention is to more effectively use the useful physiologically active components of natural products, including ginseng, Korean dendropanax, perilla, onion and seaweed, and to provide a natural product enzyme produced by fermenting the natural products with lactic acid bacteria and a method for producing the same.

To achieve the above problem, the present invention provides a method of producing a natural product enzyme using lactic acid bacteria, the method including: mixing, based on 100 parts by weight of water, 20 to 30 parts by weight of a natural product selected from the group consisting of ginseng, Korean dendropanax, perilla, onion and seaweed, 3 to 5 parts by weight of glucose, and 0.1 to 0.5 parts by weight of lactic acid bacteria, and fermenting the mixture at room temperature for 10 to 20 days.

The lactic acid bacteria are preferably a culture obtained by inoculating Lactobasillus plantarum or Leuconostoc mesenteroides into a medium containing peptone, yeast and glucose, followed by preculturing at 36° C. for 24 hours, and then further culturing the preculture in the same nutrient medium.

In the production method, before fermentation, 5 to 10 parts by weight of Apios extract is preferably further added.

The present invention provides a natural product enzyme produced by the production method.

The natural product enzyme produced by the method of producing the natural product enzyme using lactic acid bacterial according to the present invention makes it possible to effectively use the natural physiologically active components contained in the natural products and the active component which is additionally produced by lactic acid bacteria fermentation. Thus, the present invention is very useful in the food industry.

### BRIEF DESCRIPTION OF DRAWINGS

FIG. 1 is a flow chart showing a method of producing a natural product enzyme using lactic acid bacteria according to the present invention.

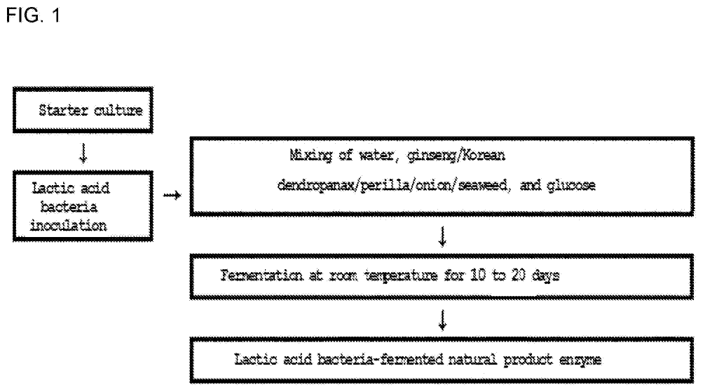

### DETAILED DESCRIPTION OF THE INVENTION

The present invention provides a method of producing a natural product enzyme using lactic acid bacteria, the method including: mixing, based on 100 parts by weight of water, 20 to 30 parts by weight of a natural product selected from the group consisting of ginseng, Korean dendropanax, perilla, onion and seaweed, 3 to 5 parts by weight of glucose, and 0.1 to 0.5 parts by weight of lactic acid bacteria, and fermenting the mixture at room temperature for 10 to 20 days.

Hereinafter, the present invention will be described in detail.

The present inventor has conducted repeated studies to effectively use the useful physiologically active components of natural products such as ginseng, Korean dendropanax, perilla, onion and seaweed, and as a result, has found that when the natural products are fermented with lactic acid bacteria to produce a natural product enzyme, it is possible to more effectively use the physiologically active components, thereby completing the present invention.

Therefore, the present invention provides a method of producing a natural product enzyme using lactic acid bacteria, the method including: mixing, based on 100 parts by weight of water, 20 to 30 parts by weight of a natural product selected from the group consisting of ginseng, Korean dendropanax, perilla, onion and seaweed, 3 to 5 parts by weight of glucose, and 0.1 to 0.5 parts by weight of lactic acid bacteria, and performing fermentation at room temperature for 10 to 20 days.

Although the natural products such as ginseng, Korean dendropanax, perilla, onion and seaweed may also be used in a finely cut state, these are preferably used in a powder form. The natural products may be used alone or as a mixture of two or more.

The lactic acid bacteria are preferably a culture obtained by inoculating Lactobasillus plantarum or Leuconostoc mesenteroides into a medium containing peptone, yeast and glucose, followed by preculturing at 36° C. for 24 hours, and then further culturing the preculture in the same nutrient medium.

The production method preferably further includes adding 5 to 10 parts by weight of Apios extract to the natural products before inoculating and fermenting the lactic acid bacteria.

The Apios is a perennial vine plant and its tuber belonging to the family Fabaceae of the order Fabales, and its scientific name is “Apios americana”. It has an edible tuber, and is also called “potato bean”, “hopniss”, “Indian potato”, “hodoimo”, “America-hodoimo”, or “American groundnut”.

The Apios extract is obtained by immersing, heating and extracting Apios in water. In a preferred embodiment, Apios may be added to a 10-fold weight of water and heated at 100° C. for 3 hours, and then the resulting filtrate may be used as Apios extract.

The addition of the Apios extract may significantly increase the lactic acid bacteria fermentation efficiency.

The fermentation is generally performed at room temperature for 10 to 20 days, and the fermentation product obtained after completion of the fermentation is named “enzyme”. That is, the natural product enzyme produced using lactic acid bacteria according to the present invention may be understood as a natural product-derived fermentation product.

Therefore, the present invention provides a natural product enzyme produced using lactic acid bacteria by the above-described production method.

The natural product enzyme of the present invention may be used as a health functional food or cosmetic composition containing the same as an active ingredient.

In a preferred embodiment, the health functional food of the present invention may be effectively used in a food and drink effective in ameliorating various oxidative stress-related diseases.

Examples of foods containing the extract of the present invention as an active ingredient include various foods, drinks, gums, teas, vitamin complexes, food supplements, etc., and these foods may be used in the form of powder, granule, tablet, capsule or drink.

The active ingredient of the present invention may generally be added to a food in an amount of 0.01 to 15 wt % based on the total weight of the food, and may be added to a health drink composition in an amount of 0.02 to 10 g, preferably 0.3 to 1 g, per on 100 ml of the health drink composition.

The health functional food of the present invention contains the enzyme as an essential component at the indicated percentage, and may further contain food-acceptable additives, for example, natural carbohydrates and various flavoring agents. Examples of the natural carbohydrates include conventional sugars, including monosaccharides such as glucose and fructose, disaccharides such as maltose and sucrose, and polysaccharides such as dextrin and cyclodextrin, as well as sugar alcohols such as xylitol, sorbitol, erythritol and the like. As the flavoring agent, there may be used thaumatin, rebaudioside A, glycyrrhizin, saccharin, aspartame, etc. The flavoring agent is used in an amount of about 1 to 20 g, preferably about 5 to 12 g, per 100 ml of the health functional food of the present invention.

In addition, the health functional food of the present invention may contain various nutrients, vitamins, minerals, flavoring agents such as synthetic flavoring agents and natural flavoring agents, colorants, pectic acid and its salt, alginic acid and its salt, organic acids, protective colloidal thickeners, pH adjusting agents, stabilizers, preservatives, glycerin, alcohol, carbonating agents that are used in carbonated beverages, etc. Additionally, the health functional food of the present invention may contain fruit flesh that is used for the preparation of natural fruit juice, fruit juice beverages or vegetable beverages. These additives may be used alone or in combination. The content of these additives is generally in the range of 0.01 to 20 parts by weight based on 100 parts by weight of the active fraction of the present invention.

In another preferred embodiment, the active ingredient of the present invention may be used as a functional cosmetic composition for antioxidant purposes.

The active ingredient of the cosmetic composition of the present invention may be contained in an amount of 0.01 to 50 wt %, preferably 0.1 to 20 wt %, more preferably 1 to 10 wt %, based on the total weight of the composition. In this content range, proper formulation stability may be ensured, and a desired antioxidant effect may be obtained.

The active ingredient of the cosmetic composition of the present invention may be contained in an amount of 0.01 to 50 wt %, preferably 0.1 to 20 wt %, more preferably 1 to 10 wt %, based on the total weight of the composition. In this content range, proper formulation stability may be ensured, and desired antioxidant, skin anti-aging and skin regeneration promotion effects may be obtained.

The composition of the present invention may further contain, in addition to the active ingredient of the present invention, a known natural product extract or other components having antioxidant, skin anti-aging and skin regeneration promotion effects, in a range that does not impair the activity of the active ingredient of the present invention.

In addition, the composition may contain components which are conventionally added to cosmetic compositions, for example, a fatty substance, an organic solvent, a solubilizing agent, a thickener, a gelling agent, a softener, an antioxidant, a suspending agent, a stabilizer, a foaming agent, an aromatic, a surfactant, water, an ionic or non-ionic emulsifying agent, a filler, a sequestering agent, a chelating agent, a preservative, vitamins, a blocker, a wetting agent, essential oil, a dye, a pigment, and a hydrophilic or lipophilic activator, which are conventionally used in the cosmetic field or the skin science field, and may be prepared as a specific formulation.

The cosmetic composition of the present invention may be prepared as any formulation which is commonly prepared in the art. For example, the cosmetic composition may be formulated into solution, suspension, emulsion, paste, gel, cream, lotion, powder, pack, soap, surfactant-containing cleanser, oil, spray and the like, but is not limited thereto. More specifically, the cosmetic composition may be prepared as formulations, including skin softener, nourishing lotion, nourishing cream, massage cream, essence, eye cream, powder foundation, emulsion foundation, wax foundation, cleansing cream, cleansing foam, cleansing water, pack, spray, powder, lip gloss, lipstick, shadow, shampoo and rinse.

When the formulation of the present invention is paste, cream or gel, it may contain, as a carrier component, animal oil, vegetable oil, wax, paraffin, starch, tragacanth, cellulose derivative, polyethylene glycol, silicone, bentonite, silica, talc, zinc oxide, or the like.

When the formulation of the present invention is powder or spray, it may contain, as a carrier component, lactose, talc, silica, aluminum hydroxide, calcium silicate or polyamide powder. In particular, when the formulation is spray, it may further contain a propellant such as chlorofluorohydrocarbon, propane/butane, dimethyl ether, or the like.

When the formulation of the present invention is a solution or an emulsion, it may contain, as a carrier component, a solvent, a solubilizing agent or an emulsifying agent. For example, the formulation may contain water, ethanol, isopropanol, ethyl carbonate, ethyl acetate, benzyl alcohol, benzyl benzoate, propylene glycol, 1,3-butylglycol oil, glycerol aliphatic ester, polyethylene glycol, a fatty acid ester of sorbitan, or the like.

When the formulation of the present invention is a suspension, it may contain, as a carrier component, a liquid diluent such as water, ethanol or propylene glycol, suspending agents such as ethoxylated isostearyl alcohol, polyoxyethylene sorbitol esters and polyoxyethylene sorbitan ester, microcrystalline cellulose, aluminum metahydroxide, bentonite, agar, tragacanth, or the like.

When the formulation of the present invention is a surfactant-containing cleanser, it may contain, as a carrier component, aliphatic alcohol sulfate, aliphatic alcohol ether sulfate, sulfosuccinic acid monoester, isethionate, an imidazolinium derivative, methyltaurate, sarcosinate, fatty acid amide ether sulfate, alkylamidobetaine, fatty alcohol, fatty acid glyceride, fatty acid diethanolamide, vegetable oil, a lanolin derivative, ethoxylated glycerol fatty acid ester, or the like.

Hereinafter, the present invention will be described in more detail with reference to specific examples. These examples are to illustrate preferred embodiments of the present invention, and it is obvious that the scope of the present invention is not limited by these examples.

### Example 1

A medium containing 5 g of peptone, 2.5 g of yeast extract and 5 g of glucose in 1 L of distilled water was prepared, and then Lactobasillus plantarum was inoculated into the medium and precultured at 36° C. for 24 hours. The preculture was further cultured in the same nutrient medium to obtain a lactic acid bacteria culture. Next, 800 L of water, 200 kg of ginseng powder, 30 kg of glucose and 1 L of the lactic acid bacteria culture were introduced and mixed in a fermenter and fermented at room temperature for 20 days, thereby producing a lactic acid bacteria enzyme.

### Example 2

A lactic acid bacteria enzyme was produced in the same manner as Example 1, except that Korean dendropanax powder was used instead of the ginseng powder.

### Example 3

A lactic acid bacteria enzyme was produced in the same manner as Example 1, except that perilla powder was used instead of the ginseng powder.

### Example 4

A lactic acid bacteria enzyme was produced in the same manner as Example 1, except that onion powder was used instead of the ginseng powder.

### Example 5

A lactic acid bacteria enzyme was produced in the same manner as Example 1, except that dry Ulva pertusa Kjellman powder was used instead of the ginseng powder.

### Example 6

A lactic acid bacteria enzyme was produced in the same manner as Example 1, except that 50 L of a hot water extract of Apios was further added before the fermentation.

### Example 7

A lactic acid bacteria enzyme was produced in the same manner as Example 6, except that Korean dendropanax powder was used instead of the ginseng powder.

### Example 8

A lactic acid bacteria enzyme was produced in the same manner as Example 6, except that perilla powder was used instead of the ginseng powder.

### Example 9

A lactic acid bacteria enzyme was produced in the same manner as Example 6, except that onion powder was used instead of the ginseng powder.

### Example 10

A lactic acid bacteria enzyme was produced in the same manner as Example 6, except that dry Ulva pertusa Kjellman powder was used instead of the ginseng powder.

### Test Example

The viable cell counters of lactic acid bacteria in the lactic acid bacteria enzymes of Examples 1 to 10 were measured according to “1.3. Microbial Testing Methods—Method for Measurement of Lactic Acid Bacteria Cell Count, described in the Korean Food Code”. The results were expressed in units of CFU/ml in Table 1 below.

TABLE 1

| | 5 days of | 10 days of | 15 days of | 20 days of | 25 days of |
|---|---|---|---|---|---|
| | fermen- | fermen- | fermen- | fermen- | fermen- |
| Samples | tation | tation | tation | tation | tation |
| Example 1 | 2.1 × 10³ | 4.2 × 10⁴ | 7.1 × 10⁵ | 1.7 × 10⁷ | 4.0 × 10⁷ |
| Example 2 | 1.5 × 10³ | 9.7 × 10³ | 1.4 × 10⁶ | 2.0 × 10⁸ | 3.5 × 10⁸ |
| Example 3 | 8.5 × 10² | 4.3 × 10⁴ | 6.0 × 10⁵ | 3.4 × 10⁷ | 5.2 × 10⁷ |
| Example 4 | 3.3 × 10³ | 5.1 × 10⁴ | 7.7 × 10⁵ | 4.2 × 10⁷ | 7.1 × 10⁷ |
| Example 5 | 4.2 × 10³ | 7.4 × 10⁴ | 5.6 × 10⁵ | 3.6 × 10⁷ | 5.5 × 10⁷ |
| Example 6 | 3.5 × 10³ | 8.4 × 10⁴ | 4.2 × 10⁶ | 2.1 × 10⁸ | 4.6 × 10⁸ |
| Example 7 | 2.2 × 10³ | 2.0 × 10⁴ | 6.1 × 10⁶ | 9.1 × 10⁸ | 1.3 × 10⁹ |
| Example 8 | 2.9 × 10³ | 6.9 × 10⁴ | 3.5 × 10⁶ | 1.9 × 10⁸ | 5.5 × 10⁸ |
| Example 9 | 5.1 × 10³ | 9.0 × 10⁴ | 8.9 × 10⁶ | 3.3 × 10⁸ | 8.7 × 10⁸ |
| Example 10 | 6.7 × 10³ | 1.3 × 10⁵ | 6.6 × 10⁶ | 3.1 × 10⁸ | 5.4 × 10⁸ |

As shown in Table 1 above, it could be confirmed that the lactic acid bacteria cell counts of Examples 1 to 5 increased as the fermentation time increased, and in particular, the growth rate of lactic acid bacteria in Examples 6 to 10 more remarkably increased.

### INDUSTRIAL APPLICABILITY

The present invention provides a natural product-derived fermented enzyme produced by inoculating lactic acid bacteria into natural products, including ginseng, Korean dendropanax, perilla, onion and seaweed, followed by fermentation, and a method for producing the same.

1. A method of producing a natural product enzyme using lactic acid bacteria, the method comprising: mixing, based on 100 parts by weight of water, 20 to 30 parts by weight of a natural product selected from the group consisting of ginseng, Korean dendropanax, perilla, onion and seaweed, 3 to 5 parts by weight of glucose, and 0.1 to 0.5 parts by weight of lactic acid bacteria, and fermenting the mixture at room temperature for 10 to 20 days.

2. The method of claim 1, wherein the lactic acid bacteria are a culture obtained by inoculating Lactobasillus plantarum or Leuconostoc mesenteroides into a containing peptone, yeast and glucose, followed by preculturing at 36° C. for 24 hours, and then culturing the preculture in the same nutrient medium.

3. The method of claim 1, further comprising adding 5 to 10 parts by weight of Apios extract.

4. A natural product enzyme containing lactic acid bacteria, obtained by the production method set forth in claim 1.

5. A natural product enzyme containing lactic acid bacteria, obtained by the production method set forth in claim 2.
